(19) United States
(12) Patent Application Publication
(10) Pub. No.: US 2006/0016890 A1
(43) Pub. Date: Jan. 26, 2006

(54) Automatic planar image capture device

(76) Inventor: Alex Chou, Chung-Ho City (TW)

Correspondence Address: TRANSPACIFIC LAW GROUP, 617 NORTH DELAWARE STREET, SAN MATEO, CA, 94401, US

(21) Appl. No.: 10/897,065

(22) Filed: Jul. 21, 2004

(51) Int. Cl. G06K 7/10

(52) U.S. Cl. 235/454

(57) ABSTRACT

An automatic planar image capture device comprises: an optical image input module comprising an optical lens, an image sensor and an image preprocessor to capture images formed on a plan and to convert the captured images into a digital format; a zooming module to adjust focus and sensed area of said optical lens of said optical image capture module; an image processing module to process image captured by said optical image capture module, including recognition of outer frame, removal of outer frame, tilt adjustment, reduction of reflective image and noise and sharpening; and a memory device to store in-process and processed image data. According to another embodiment of this invention, the automatic planar image capture device further comprises: a control device, including a control interface to allow user to input control parameters, to provide input control parameters to said image processing module; and a communication interface to transmit the captured and processed images to an output device. Graphics and characters projected or drawn on a large area plan may thus be captured, processed and transmitted through wired or wireless communication channel to a computer, communication network or an output device to be displayed, stored or otherwise output directly.

### FIELD OF THE INVENTION

The present invention relates to an automatic planar image capture device, especially to a device to automatically capture image projected or displayed on a large area plan and to transmit the captured image to a computer, communication equipment or an output device.

### BACKGROUND OF THE INVENTION

In all kinds of meeting, negotiation or discussion, it is popular to project to or to display on a plan images to serve as bases of discussion. Such discussion is called “presentation”.

When contents of a presentation are projected to a large area plan, several methods are frequently used. The first approach is to generate descriptions of image by a computer. The descriptions are input into a graphic projector, which converts them into graphic signals according to particular protocols. The graphic signals are organized and projected onto the large area plan to form image. Applicable image descriptions include the PPT files generated by Power Point®. Another approach to project image onto the large area plan is to project image affixed on a planar or three-dimensional recording medium, or the image of the medium itself by a projecting machine, generally called “over-head projector”. If the image is not projected onto the large area plan, it may be drawn on the plan, such as a white board or a blackboard, manually. Often, the image contains graphics and characters.

Nowadays, participants of the business meeting, negotiation or discussion are not necessarily in only one location. It is possible to use the facility of teleconference to transmit images between or among computer equipments through intranet or internet, such that people in separate locations can participate in a meeting at the same time. If the planar images are those generated by a computer, it is possible to transmit such images to computer equipments at separate locations. However, if the planar images are those projected from a recording medium or drawn on the plan manually, it is very difficult to conduct real-time and dynamic transmission of the images.

Nevertheless, during or after the business meeting, negotiation or discussion, it is always necessary to print out the content of the presentation or the discussion. Under the current technology, it is necessary to use several equipments, such as optical scanner, digital camera, computer graphic processing software and other devices to capture and to process the images before they may be output.

It is thus necessary to provide an automatic planar image capture device to capture image formed on a large area plan, such that the captured image may be printed, stored and transmitted directly.

It is also necessary to provide an automatic planar image capture device for real-time inputting, printing and transmission of planar images.

It is also necessary to provide an automatic planar image capture device to enable direct output of planar images no matter what source of the images is.

### OBJECTIVES OF THE INVENTION

The objective of this invention is to provide an automatic planar image capture device to capture image formed on a large area plan, such that the captured image may be printed, stored and transmitted directly.

Another objective of this invention is to provide an automatic planar image capture device for real-time inputting, printing and transmission of planar images.

Another objective of this invention is to provide an automatic planar image capture device to enable direct output of planar images no matter what source of the images is.

### SUMMARY OF THE INVENTION

According to this invention, the automatic planar image capture device comprises: an optical image input module comprising an optical lens, an image sensor and an image preprocessor to capture images formed on a plan and to convert the captured images into a digital format; a zooming module to adjust focus and sensed area of said optical lens of said optical image capture module; an image processing module to process image captured by said optical image capture module, including recognition of outer frame, removal of outer frame, tilt adjustment, reduction of reflective image and noise and sharpening; and a memory device to store in-process and processed image data. According to another embodiment of this invention, the automatic planar image capture device further comprises: a control device, including a control interface to allow user to input control parameters, to provide input control parameters to said image processing module; and a communication interface to transmit the captured and processed images to an output device. Graphics and characters projected or drawn on a large area plan may thus be captured, processed and transmitted through wired or wireless communication channel to a computer, communication network or an output device to be displayed, stored or otherwise output directly.

These and other objectives and advantages of this invention may be clearly understood from the detailed description by referring to the following drawings.

### BRIEF DESCRIPTION OF THE DRAWINGS

FIG. 1 shows the systematic diagram of one embodiment of the automatic planar image capture device of this invention.

FIG. 2 shows the systematic diagram of another embodiment of the automatic planar image capture device of this invention.

### DETAILED DESCRIPTION OF THE INVENTION

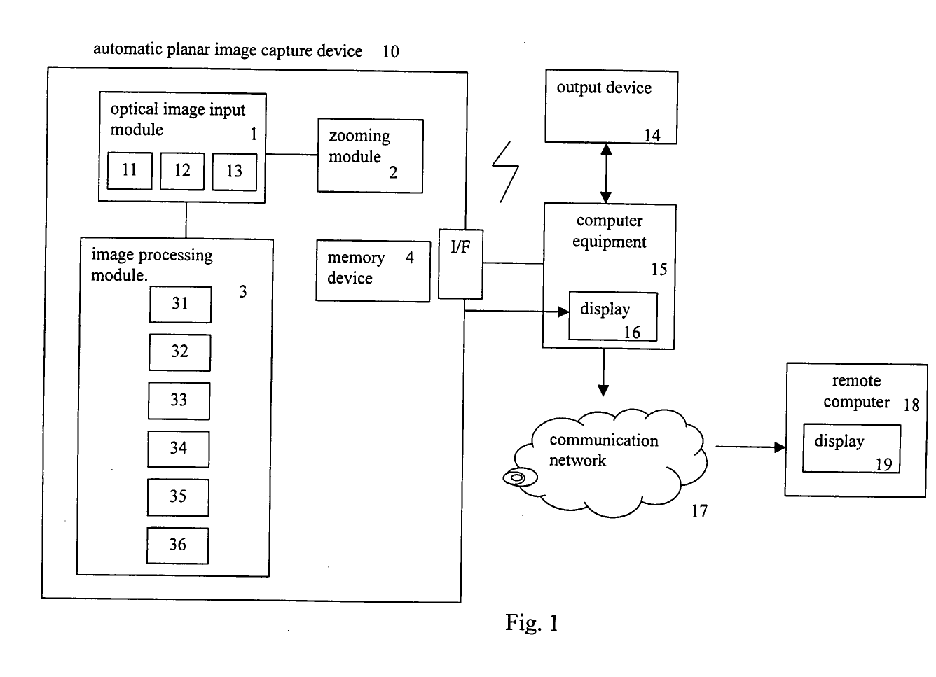

The present invention provides an automatic planar image capture device to capture images formed on a large area plan and to automatically process the captured image, so that the images suit direct display, store or output. According to one embodiment of this invention, the images are captured and processed for directly display, transmission, store or output by a computer equipment. According to another embodiment, on the other hand, the captured images are for direct printing purposes. FIG. 1 shows the systematic diagram of the first embodiment of this invention.

As shown in this figure, the automatic planar image capture device of this invention 10 is in connection with a computer equipment 15 or an output device 13 through a communication channel. The communication channel may be a wired communication channel such as IEEE 1394, USB, RS-232 etc., or a wireless communication channel such as infrared communication channel, WiFi 802.11x, Bluetooth or any other wireless communication protocol that complies with the national communication regulations. The computer equipment 15 is provided with a display 16 to display images as they are captured and processed by the automatic planar image capture device 10. The computer equipment 15 may also in connection with a network communication equipment 17 through a wired or wireless communication channel, such that the network communication equipment 17 may transmit the captured and processed images to a remote computer equipment 18, to be displayed on the display device 9 of the remote computer equipment 18. The computer equipment 5 may be in connection with an output device, such as a printer 14, such that the captured and processed images may be printed by the printer 14 directly. The computer equipment 15 and the printer 14 may be connected by a wireless communication channel such as Bluetooth or infrared communication channel.

Also as shown in FIG. 1, the automatic planar image capture device of this invention 10 comprises: an optical image input module 1 comprising an optical lens 11, an image sensor 12 and an image preprocessor 13 to capture images formed on a plan and to convert the captured images into a digital format; a zooming module 2 to adjust focus and sensed area of said optical lens of said optical image capture module; an image processing module 3 to process image captured by said optical image capture module, including recognition of outer frame, removal of outer frame, tilt adjustment, reduction of reflective image and noise and sharpening; and a memory device 4 to store in-process and processed image data. Graphics and characters projected or drawn on a large area plan may thus be captured, processed and transmitted through the wired or wireless communication channel to the computer equipment 15, the communication network 17 or the output device 14 to be displayed at the displays 16, 19, stored in the local computer 15 or the remote computer 18, printed by the printer 14 or otherwise output directly.

In this embodiment, the optical image input module 1 generally comprises an optical lens 11, an image sensor 12 and an image preprocessor 13. The optical lens 11 concentrates the planar image to the image sensor 12. The image sensor may be a charge couple device or a CMOS sensor array. The concentrated image is sensed by the image sensor 12 and converted into a digital format by the image preprocessor 13. The zooming module 2 controls focus of the optical lens 11. In another embodiment of this invention, the zooming module 2 controls the sensed area of the image sensor 12. In such case, the optical lens is preferably a zoom lens, either automatic, manual controlled or semi-automatic. It is thus possible to use zoom-in and zoom-out modes of the zoom lens to capture planar images. Of course, if the image sensor is a planar image sensor array, the optical lens 11 and the zooming module 2 may be omitted.

Although it is possible in the conventional art to provide a PC camera or a digital camera to capture images formed on a plan and to display, transmit or output such images using a computer equipment, network communication equipment or an output device, the images so captured inevitably inherit distortions and errors. Such distortions and errors are caused by, such as, reflection from background of formed image, tilt deformation, smearing at edges of image etc. Nonetheless, when the formed image is too broad (wide) to be captured by one shot of the image capture device, it is not possible to output such image without manual processing.

The image processing module 3 of this invention provides a part of all of the following modules to adjust and to calibrate the captured images:

Reflection image and noise reduction module 31: This module identifies and removes background light components that exist in the captured images due to the high density carrier light of the image generated by the image projector. Applicable technology to identify such background light components includes those in the known art. A conventional image processing circuit or software may be used in this reflection image and noise reduction module 31 to identify such background light components and to remove them from the captured image. In addition, noises contained in the captured image may also be removed using similar technology.

Tilt adjustment module 32: General speaking, when an image is projected to a large area plan from a projector, tilt deformation is easily found in such projected image. When such deformed image is further captured by a small size image sensor at a particular position, the deformation is further increased. In order to reduce the deformation of the image, the tile adjustment module 32 adjusts the captured image, such that the image after processing is normalized. As to technology used in the tilt adjustment module 32, it may be any conventional art. Those skilled in the art may easily adopt a known technology to realize such adjustment of tilt deformation.

Edge sharpening module 33: This edge sharpening module 32 identifies edges of the captured image and sharpens them to appear as lines. As images projected onto a large area plan are enlarged, their edge lines are smeared. When they are sensed by an image sensor, the edges are made even unrecognizable. Such phenomenon happens to where the images were drawn manually, too. The edge sharpening module 33 identifies correct edge lines of the captured image and modifies the edge lines, such that the edge lines appear in the processed images correctly. Again, any edge sharpening circuit or software may be used in the edge sharpening module 33 to sharpen the edges of the captured image.

Frame processing module 34: The frame processing module 34 identifies outer frames of the captured image and removes the outer frames. This module 34 helps to modify the captured image, such that only the content component of the captured image is displayed, stored, transmitted or printed. Suited technology to identify and to remove the outer frame of the captured image includes those known by people skilled in the art. Detailed description thereof is thus omitted.

Image editing module 35: When the image to be captured is too broad (too wide) to be captured in one shot, the image editing module 35 combines two or more images into one long image by overlapping the duplicated portions of the adjacent images. Such technology is available in the conventional art. Those skilled in the art may be able to adopt any of the known art to realize the objective of the image editing module 35.

In addition, the image processing module 3 may further comprises an alert module 36 to generate alert signals when the image is too broad, too dark, too light, or distance between the image and the automatic planar image capture device is too far or too close to be correctly processed. It also generates alert signals when it is difficult to focus, to identify the outer frame or to conduct other processing, or when the quality of the processed image is below standard. For this purpose, there are many known art in the image processing technology to realize.

In order to conduct the processing of the captured image, a memory device 4 is provided to store image data being processed or after process. The processed image data are sent to the computer equipment 15 to be displayed, stored, transmitted or printed by a proper device. In another embodiment of this invention, a buffer memory is used to store the captured image data and the processed image data are transmitted to the computer equipment 15 through a card reader (PCI interface), a USB interface, a 1394 interface, an 802.11x interface, a Bluetooth interface or an infrared interface.

The automatic planar image capture device of this invention may be so designed that the captured and processed image is printed by an output device in connection with the automatic planar image capture device. In such a case, the automatic planar image capture device may be prepared as a stand alone device to be positioned on a table of the conference room, aimed at the plan where the image to be captured is formed.

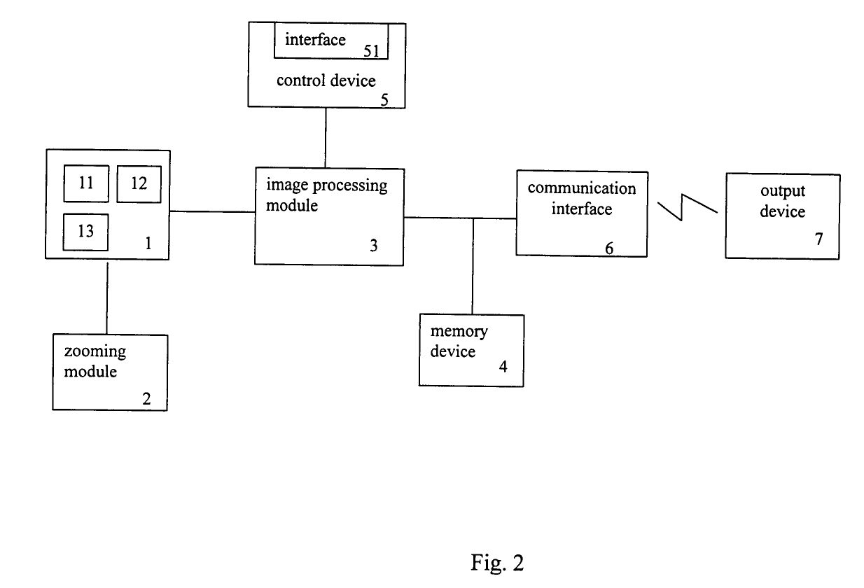

FIG. 2 shows the systematic diagram of the second embodiment of the automatic planar image capture device of this invention. Component that are the same as those of FIG. 1 are labeled with the same numbers. As shown in this figure, the automatic planar image capture device of this embodiment 10 comprises: an optical image input module 1 comprising an optical lens 11, an image sensor 12 and an image preprocessor 13 to capture images formed on a plan and to convert the captured images into a digital format; a zooming module 2 to adjust focus and sensed area of said optical lens of said optical image capture module; an image processing module 3 to process image captured by said optical image capture module, including recognition of outer frame, removal of outer frame, tilt adjustment, reduction of reflective image and noise and sharpening; a memory device 4 to store in-process and processed image data; a control device 5, including a control interface 51 to allow user to input control parameters, to provide input control parameters to said image processing module; and a communication interface 6 to transmit the captured and processed images to an output device 7.

The automatic planar image capture device 10 of this embodiment has the same or similar design in its optical image input module 1, zooming module 2, processing module 3 and the memory 4, provided that in this embodiment, the automatic planar image capture device 10 may be in connection with the output device 7 directly, although it may establish its connection with a computer device or a network communication device (both not shown).

The control device 5 includes a control interface 51 to allow user to input control parameters. The control device 5 may transmit the input control parameters to the image processing module 3 for processing the captured image. The control interface 51 may include switches or other switching device, selection device or software keys etc. such that it is easy for the user to input necessary control parameters. Control parameters to be input through the control interface 51 include: parameters relating to sensed scope or focus of the optical lens 11, parameters relating to image processing, such as size, resolution, brightness, contrast, filtering, tilt deformation, confirmation of outer frames, and all kinds of function keys, such as image capture, image printing, image transmission etc. In another embodiment of the present invention, a memory function is provided such that control parameters frequently used in particular locations are stored to facilitate reuse of the parameters. With this function, users don't need to input control parameters from time to time. Parameters so input are used as bases of processing by the image processing module 3.

The communication interface 6 provides a wired or wireless communication channel between the automatic planar image capture device 10 and the output device 7. The communication channel to be used may be a wired communication channel, such as IEEE 1394, USB, RS-232 communication channel or a wireless communication channel such as an infrared, WiFi 802.11x, Bluetooth etc. communication channel. The communication interface 6 also provides a transceiver to transmit the captured and processed images to the output device 7, which is preferable a printer or other suited output device If the output device 7 is a printer, it may be a laser printer, an inkjet printer or others. The output device 7 may also be a flat computer, a plasma display, a liquid crystal display or other displaying devices. It may be a standalone output device or the output device of a computer equipment. When the output device 7 is connected to the automatic planar image capture device 10, initialization of the connection may be necessary, such that proper control parameter and communication channel may be established.

### EFFECTS OF THE INVENTION

Using the automatic planar image capture device of this invention, images containing graphics and/or characters projected to or drawn on a large area plan may be captured and processed automatically to obtain image suited for direct output or processing. The captured and processed images may be printed directly. They may also be printed, stored or displayed in a local computer or transmitted and displayed, stored or printed by a remote computer. Real-time and dynamic capture of planar images is thus realized. The automatic planar image capture device of this invention is simple, low cost and easy to use. Efficiency of meeting, negotiation and discussion may thus be conducted.

As the present invention has been shown and described with reference to preferred embodiments thereof, those skilled in the art will recognize that the above and other changes may be made therein without departing from the spirit and scope of the invention.

What is claimed is:

1. An automatic planar image capture device, comprising:
an optical image input module to capture images formed on a plan and to convert the captured images into a digital format;
an image processing module to process image data captured by said optical image capture module, such that the processed image data are suited for direct output;
a memory device to store in-process and processed image data; and
an output interface to transmit processed image data to a computer device, an output device or a network device.

2. The automatic planar image capture device according to claim 1, wherein said optical image capture module comprises an optical lens and an image sensor.

3. The automatic planar image capture device according to claim 2, further comprising a zooming module to adjust focus and sensed area of said optical lens of said optical image capture module.

4. The automatic planar image capture device according to claim 1, wherein said optical image capture module comprises a planar sensor matrix.

5. The automatic planar image capture device according to claim 1, wherein processing of said image processing module includes including recognition of outer frame, removal of outer frame, tilt adjustment, reduction of reflective image and noise and sharpening.

6. The automatic planar image capture device according to claim 5, wherein processing of said image processing module further includes editing two consecutive images into one long image.

7. The automatic planar image capture device according to claim 5, wherein processing of said image processing module further includes generating an alert when quality of said processing is below a standard.

8. The automatic planar image capture device according to claim 1, wherein said output interface comprises at least one selected from the group consisted of PCI, USB, 1394, 802.11X, Bluetooth and infrared interfaces.

9. The automatic planar image capture device according to claim 1, wherein said output interface comprises a wireless communication interface connectable to a printer.

10. The automatic planar image capture device according to claim 1, further comprising a control device, including a control interface allowing user to input control parameters and control signals; wherein said control device may provide said control parameters to said image processing module.

11. The automatic planar image capture device according to claim 10, wherein said optical image capture module comprises an optical lens and an image sensor.

12. The automatic planar image capture device according to claim 11, further comprising a zooming module to adjust focus and sensed area of said optical lens of said optical image capture module.

13. The automatic planar image capture device according to claim 10, wherein said optical image capture module comprises a planar sensor matrix.

14. The automatic planar image capture device according to claim 10, wherein processing of said image processing module includes including recognition of outer frame, removal of outer frame, tilt adjustment, reduction of reflective image and noise and sharpening.

15. The automatic planar image capture device according to claim 14, wherein processing of said image processing module further includes editing two consecutive images into one long image.

16. The automatic planar image capture device according to claim 14, wherein processing of said image processing module further includes generating an alert when quality of said processing is below a standard.

17. The automatic planar image capture device according to claim 10, wherein said output interface comprises at least one selected from the group consisted of PCI, USB, 1394, 802.11X, Bluetooth and infrared interfaces.

18. The automatic planar image capture device according to claim 10, wherein said output interface comprises a wireless communication interface connectable to a printer.

19. The automatic planar image capture device according to claim 10, wherein said control parameters include: parameters relating to scope of image to be captured, parameters relating to focus of optical lens, parameters relating to image processing, such as size, resolution, brightness, contrast, noise filtering, deformation and identification of outer frame.

20. The automatic planar image capture device according to claim 10, wherein said control device provides a memory function to store sets of control parameters to be used in relating to particular location or environment.
